(19) United States
(12) Patent Application Publication
(10) Pub. No.: US 2010/0020254 A1
(43) Pub. Date: Jan. 28, 2010

(54) MULTI-PANEL VIRTUAL IMAGE DISPLAY

(76) Inventor: Zheng Jason Geng, Rockville, MD (US)

Correspondence Address: THORPE NORTH & WESTERN, LLP., P.O. Box 1219, SANDY, UT, 84091-1219, US

(21) Appl. No.: 12/505,674

(22) Filed: Jul. 20, 2009

Related U.S. Application Data
(60) Provisional application No. 61/082,865, filed on Jul. 23, 2008.

(51) Int. Cl. G02F 1/1335; G03B 21/00

(52) U.S. Cl. 349/15; 353/7

(57) ABSTRACT

A multiple panel system and method for displaying a virtual image viewable from multiple viewing angles is provided. Reflective viewing panels are arranged relative to one another in at least a partially closed enclosure arrangement. A display screen is oriented with respect to the viewing panels such that an image displayed on the display screen creates a virtual image viewable from multiple angles. An image formation mechanism is operable to display an image onto the display screen.

### PRIORITY DATA

This application claims the benefit of U.S. Provisional Patent Application Ser. No. 61/082,865, filed on Jul. 23, 2008, which is incorporated herein by reference.

### BACKGROUND

Various forms of advertising are used by individuals, business, and other organizations for a variety of reasons, such as to provide information or to attract potential customers to advertised products. Advertising often uses print or digital media to reach an audience.

Numerous varieties of sign and poster displays are currently used to exhibit advertisements on billboards, buildings, the sides of vehicles, etc. These displays may exhibit an advertisement on a display panel made of large canvas or plastic sheets secured to a flat surface by a mounting. Smaller display panels are often mounted within enclosures to protect the display panel from the elements. However, such enclosures may be prohibitively cumbersome for larger display panels, and these typically remain exposed. Over time, the exposed display panel tends to wrinkle and tear until the advertisement becomes unattractive, unappealing, and ultimately unintelligible. Whether using small or large display panels, time and money must be frequently expended to remove old advertisements and replace the old advertisements with new advertisements. As a result, many forms of advertising are implementing digital displays such as LCD screens and the like to overcome some of the shortcomings of non-digital advertisements.

When digital advertising began to be used in signage and other displays, the digital advertisements were able to attract viewers by providing a new and interesting way to deliver the advertisement. For example, digital signage may incorporate video or provide a rotation of any number of advertisements. These features were not possible with traditional, non-digital signage. However, as digital signage becomes more commonplace, viewers may be less inclined to look at advertisements displayed thereon. Furthermore, despite the advances provided by digital advertising, some drawbacks can hinder the effectiveness of the advertising. For example, an LCD display screen may be best viewed when directly facing the screen. If a viewer were to look at the LCD display screen from an angle, the image on the display screen may be dimmed or be partially or wholly unviewable due to the nature of LCD screens. Viewers standing behind the LCD display screen would simply be unable to view any of the content on the screen, but only be able to see the back of the display device. Non-digital signage suffered from similar drawbacks.

### SUMMARY OF THE INVENTION

It has been recognized that there is a need for a form of advertising which can overcome drawbacks to current digital and non-digital advertising displays, which can allow viewing of an image from multiple angles, and which can provide a novelty or “wow” factor for drawing viewers to look at the advertisements. Accordingly, the present invention provides a multiple panel system and method for displaying a virtual image viewable from multiple viewing angles. Reflective viewing panels are arranged relative to one another in at least a partially closed enclosure arrangement. A display screen is oriented with respect to the viewing panels such that an image displayed on the display screen creates a floating virtual image viewable from multiple angles. An image formation mechanism is operable to display an image onto the display screen.

### BRIEF DESCRIPTION OF THE DRAWINGS

FIG. 1 is a diagrammatic view of a prior art system for displaying a virtual image to a viewer;

FIG. 2 is a perspective view of a multi-panel virtual image display system in accordance with an embodiment;

FIGS. 3A-3D are top and perspective views of multi-panel virtual image display system panel configurations in accordance embodiments;

FIG. 4 is a cross-sectional side view of a multi-panel virtual image display system using a projector and with a screen above the display panels in accordance with an embodiment;

FIG. 5 is a cross-sectional side view of a multi-panel virtual image display system using a projector and with a screen below the display panels in accordance with an embodiment;

FIG. 6A is a cross-sectional side view of a multi-panel virtual image display system using an active display and with a screen above the display panels in accordance with an embodiment;

FIG. 6B is a cross-sectional side view of a multi-panel virtual image display system using an active display and with a screen below the display panels in accordance with an embodiment;

FIG. 7 is a diagrammatic view of a system for tracking viewers and viewer eyeballs in accordance with an embodiment; and

FIG. 8 is a flow diagram of a method for displaying a virtual image using coherence combinations of multiple reflective panel surfaces in accordance with an embodiment.

### DETAILED DESCRIPTION OF EXAMPLE EMBODIMENT(S)

Reference will now be made to the exemplary embodiments illustrated, and specific language will be used herein to describe the same. It will nevertheless be understood that no limitation of the scope of the invention is thereby intended. Additional features and advantages of the invention will be apparent from the detailed description which follows, taken in conjunction with the accompanying drawings, which together illustrate, by way of example, features of the invention.

As described above, there exists a need for a form of advertising which can overcome drawbacks to current digital and non-digital advertising displays, which can allow viewing of an image from multiple angles, and which can provide a novelty or “wow” factor for drawing viewers to look at the advertisements. Provided herein is a multi-panel virtual image display for displaying multi-dimensional images which can be viewed from multiple viewing angles. In some embodiments, the displayed images can be viewed from a full 360°.

The multi-panel virtual image display disclosed herein utilizes coherence combination of multiple reflective surfaces (or panels) to create an appearance of objects that can be viewed from multiple viewing angles, and in some embodiments from a full 360° of circumferential or panoramic viewing angles. The panels can form an enclosed or partially enclosed display system and allow for dynamic two or three dimensional images to appear as if floating in mid-air and viewable from as wide a field as 360° in the surrounding area. The multi-panel virtual image display can allow for vivid eye-catching video, displays, or other advertisements. The multi-panel virtual image display may be used for live events, product launches, trade show presentations, retail displays, large-scale digital signage, demos, conferences, audiovisual artistic performances, and virtually any other event, location, or situation in which a display or advertisement of some form is desired. In competitive advertising or promotional environments the display may effectively attract attention to the display or advertisement and track a number of viewers.

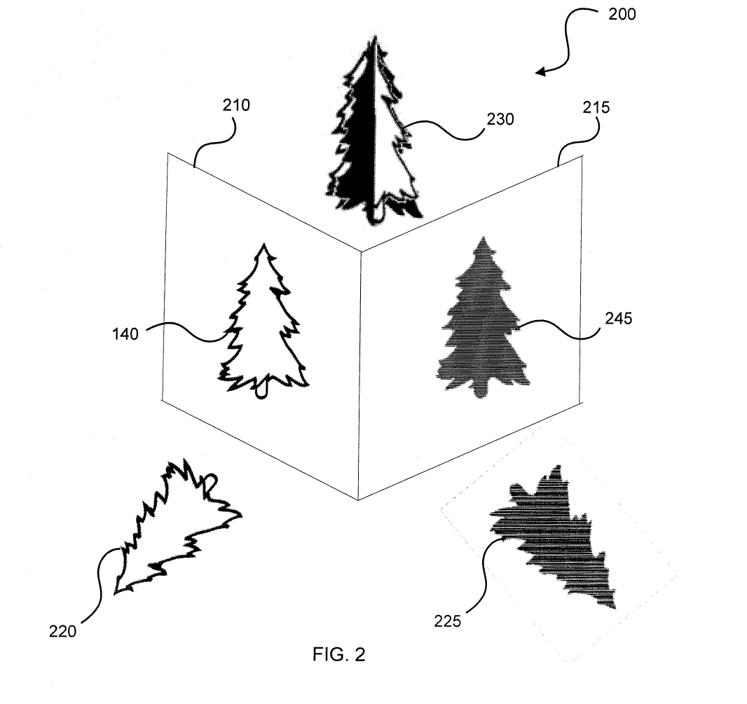

In accordance with one embodiment of the present invention, a multiple panel system or apparatus is provided for displaying a virtual image viewable from multiple viewing angles. Such a system or apparatus generally includes a plurality of reflective viewing panels arranged relative to one another in at least a partially closed enclosure arrangement. As used herein, “at least a partially closed enclosure arrangement” may refer to an arrangement of viewing panels in which an edge of at least two viewing panels are positioned closely to one another and a surface of a first of the at least two viewing panels is not aligned with a surface of a second of the at least two viewing panels. For example, FIG. 2, which will be discussed in further detail below, shows an at least a partially closed enclosure arrangement having two flat viewing panels 210, 215 with edges placed closely together and where the panels are positioned at an angle with respect to one another (or in other words, planar surfaces of the flat panels are not aligned. Such alignment may result in effectively creating one larger flat planar surface rather than providing additional viewing angles not available with a single flat surface). The system further includes a display screen oriented with respect to the viewing panels such that an image displayed on the display screen creates a floating virtual image viewable from multiple angles. An image formation mechanism may operable to display an image onto the display screen.

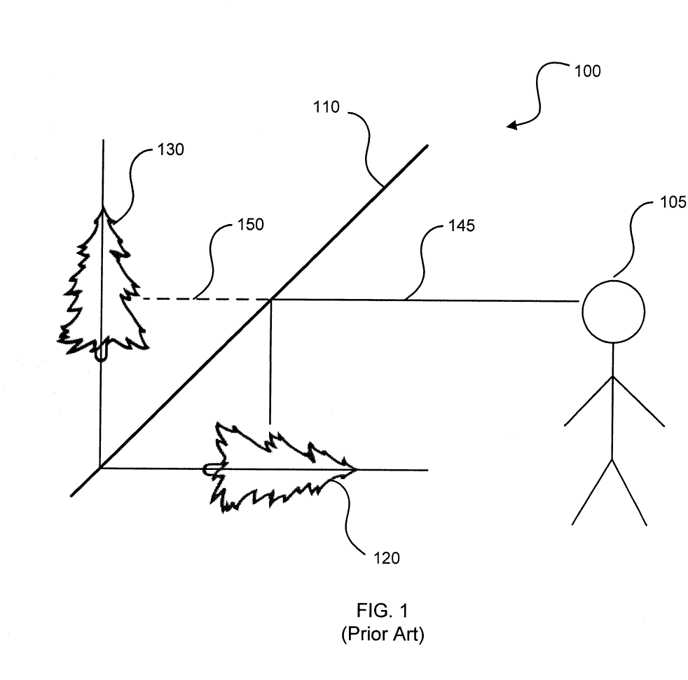

FIG. 1 illustrates a known system 100 for creating a virtual image. A reflective surface 110 (which may or may not be transparent) is provided. In many applications the reflective surface may comprise a glass substrate. The reflective surface may be at a 45° angle as shown in the figure, or may be at any other angle as may be suitable for producing the desired affect. For example, the reflective surface may be vertically oriented. An object, or an image 120 of an object, is provided. The image is reflected off of the reflective surface and towards a viewer 105. The image can appear as a virtual image 130 behind the reflective surface.

In optics, a real image may be described as an image in which outgoing rays from a point on an object pass through a single point. For example, real images may be observed as projected onto an opaque screen, although real images may be formed without use of a screen. A virtual image may be described as an image in which outgoing rays from a point on an object never actually intersect at a point. For example, when looking at a flat mirror, a viewer can perceive an image of the viewer which appears “behind” the mirror at a same distance behind the mirror as the viewer is in front of the mirror. Although rays of light may appear to come from behind the mirror, light from the source spreads and exists in front of the mirror. In drawings of optical systems, virtual rays are conventionally represented by dotted lines 150. Optical rays 145 represent paths on which light actually travels. A virtual ray can represent perceived paths as perceived by an observer looking into the optical device. A point on a virtual image may be located where virtual rays intersect.

Referring to FIG. 2, a system 200 is shown for providing a virtual image which can be viewed from more viewing angles than may be available with a single reflective surface or panel. In one aspect, the reflective surface may be transparent or partially transparent. Use of transparent panels can allow viewers to see through the display system. This can allow for increased depth perception and enhance an appearance of a virtual image appearing to float in mid-air and viewable from multiple viewing angles.

Real images or objects 220, 225 may be provided. The images may be reflected off of a surface of reflective panels 210, 215. Images 240, 245 represent an image reflecting off of the reflective panels and not necessarily what will be seen by a viewer. As described above, a virtual image 230 may appear behind the reflective panels. In one aspect, images 220, 225 may be multi-dimensional images (which may be formed by combinations of single-dimensional images), such as two or three dimensional images. Image 220 has been colored white and image 225 colored black to show an interaction of the two virtual images. While the two images 220, 225 may be different to provide different images from different angles around the system, use of similar images may create a coherent panoramic effect in which a viewer can view the virtual image at a first angle through a first reflective panel and view a same or different view of a same or similar image at a second angle through a second reflective panel. In some cases the source image may comprise a stereo image the virtual image may comprise a virtual stereo image. Stereo imagery may be used to enhance a perception of image depth.

Providing similar images 220, 225 and a plurality of reflective panels with edges positioned closely together can allow for minimal seams or even a substantially seamless transition or “handover” from viewing a virtual image on one viewing panel to viewing the virtual image on another viewing panel. In other words, the virtual image may appear as a single multi-dimensional object which a viewer may be able to at least partially walk around without substantial discrepancies in size, shape, position, etc. of the virtual image such that the virtual image appears to be a single virtual image from any available viewing angle.

A more precise description of the optical interactions for achieving the handover is as follows. As shown in FIG. 2, a real object image 220 is reflected by a reflective surface 210 at 240 to produce a virtual image 230. A distance from 220 to 240 is equal to a distance from 240 to 230. Because a structure and configuration of panel 215 in this embodiment is the similar to that of panel 210, virtual images from each panel can be located in a same location and aligned in 3D space. When a viewer observes the virtual image from an intersection point or seam between the two reflective panels, virtual images from the real images 220, 225 may appear overlapped in a same size and orientation, and be co-located in a same 3D position. A transition between two viewable virtual images from two adjacent panels will be seamless or substantially seamless.

To further enhance a panoramic viewing experience, different panels may create virtual images of different sides of a same object. For example, a three dimensional model of a car may be displayed. When viewing the car through one viewing panel, a viewer may see a front of the car when a front view of the car is the source image for that viewing panel. The viewer may walk around the system to an adjacent side panel and view a side of the car when a side view of the car is a source image for the side viewing panel. Thus three dimensional virtual images created by the system may provide a more immersive three-dimensional viewing experience by allowing a viewer to walk around the virtual image and view the virtual image from any side and/or any angle. In one aspect, the virtual image may be rotated while being displayed. Each image source may be synchronized such that each source provides a similar degree of rotation of the image but from different starting points. For example, using the car example, when the front view of the car is rotated around 45° to the left, the side view of the car can also rotate 45° to the left.

In one aspect, the plurality of viewing panels may be integrally formed as a single device having multiple reflective panels. In another aspect, the plurality of viewing panels may comprise separate panels which may be attached at one or more edges or positioned closely together. For example, the edges of the panels may be physically touching or there may be a space between the edges. The panel configurations may include a spacer in the space between the edges. In one aspect the panels may be held in position by a frame. In some embodiments, the panels may be formed in a closed polygon cone arrangement.

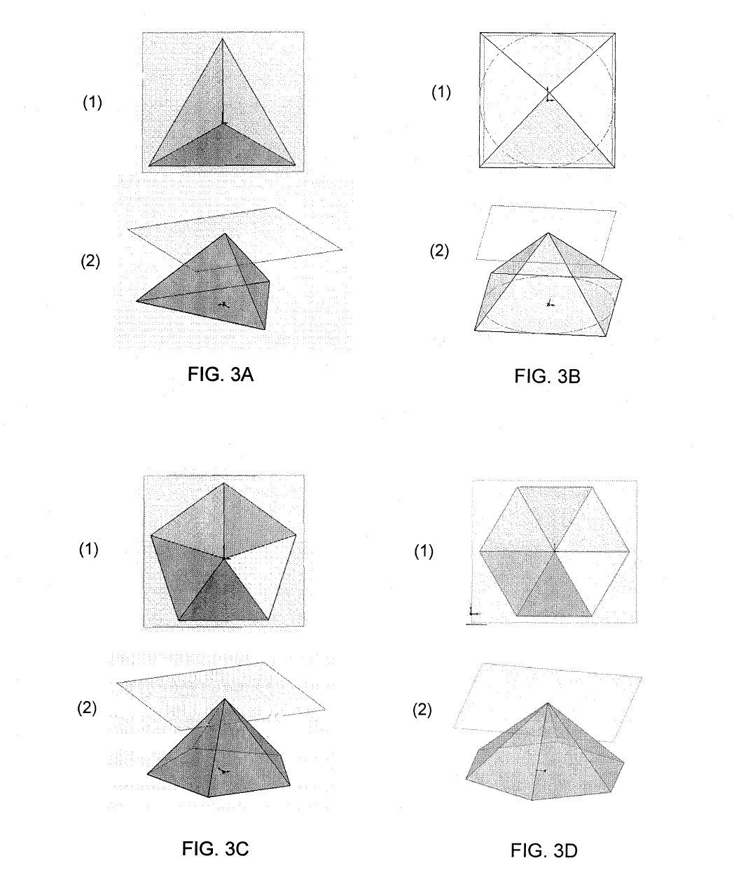

The plurality of viewing panels used to create the virtual image viewable from multiple viewing angles may comprise any number of a plurality of viewing panels. For example, referring to FIGS. 3A-3D, three-, four-, five-, and six-panel arrangements are shown from top (1) and perspective (2) views. FIGS. 3A-3D depict the panel arrangements as polygonal shapes converging at an apex. However, the panels need not be flat, polygonally shaped, arranged in polygon arrangements, or converge. Also shown in FIGS. 3A-3D are quadrilaterals positioned above the panel arrangements. The quadrilaterals represent a screen or display panel on which an image is formed, which image is reflected off of the reflective panels to create a virtual image. The screens are shown in the figures as transparent to allow better viewing of the reflective panel arrangements beneath the screens, but maybe opaque or have any suitable degree of transparency.

FIG. 3A presents a three-panel display system configuration in accordance with an embodiment, wherein each panel is inclined at a same fixed angle (such as 45°) with respect to a horizontal base. Base lines (e.g., the intersection between the panels and the base) of the three panels are at 120°, forming an equilateral triangle from the three panels and causing them to converge at an apex. The screen can be placed in any suitable location for enabling an image reflected by the panels to be viewable by observers. As shown in FIGS. 3A-3D and in accordance with one embodiment, the base lines of the multi-panel configurations may form equiangular polygons with a same number of sides as a number of panels (e.g. square (4 sides, 4 panels), pentagon (5 sides, 5 panels), etc.). As will be described, the reflective panel configurations and a screen or display associated with the reflective panel configurations may be oriented as shown, or upside down, or sideways or any other suitable configuration for providing a virtual image to a viewer.

Regardless of a number of reflective panels used in a system, the panels may be configured in a similar size, shape, angular position, etc. so as to provide a proper alignment and seamless transition of virtual images from one reflective panel to the next. Also, though many of the embodiments shown in the figures depict triangularly shaped reflective panels, the shape need not been a triangle or any particular shape. The panels may have, and form, an irregular shape. A surface of the panels does not need to be flat. Additionally, a shape and/or number display panels does not necessarily need to be the same shape and/or number of display screens or image formation devices.

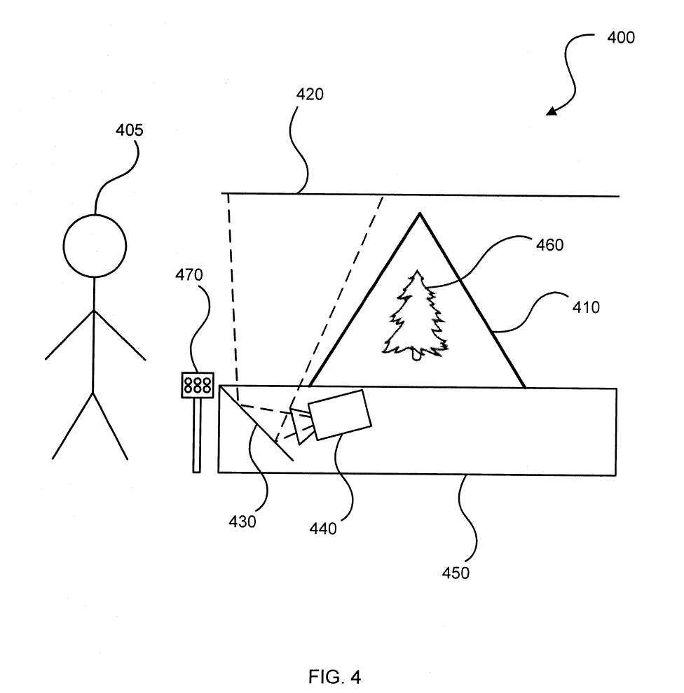

FIG. 4 shows a cross-sectional side view of a multi-panel virtual image display system 400 using a projector 440 and with a screen 420 above reflective display panels 410 in accordance with an embodiment. A viewer 405 can stand near a base 450 of the system and view a virtual image 460 produced inside of a pyramidal shaped reflective panel arrangement. An image formation mechanism (a projector in this embodiment), may be used to project an image onto the screen above the reflective panels. In one aspect, the projector may project an image onto a reflective surface, such as a mirror 430, which may be configured to reflect the projected image onto the screen. In another aspect, the projector may directly project an image onto the screen. The projector can be positioned in any suitable location or configuration for projecting or producing images on the screen. As shown in the figure, the projector can be positioned near a base region of the plurality of viewing panels, and the display screen is positioned near an apex region of the plurality of viewing panels. In another embodiment, the projector can be above the screen. Rays from the screen can reflect off of the reflective viewing panels to produce the virtual image. The virtual image may appear to be floating within the arrangement of reflective surfaces and be visible to a viewer standing anywhere around the circumference of the system. The reflective panels, or viewing panels, can be oriented with respect to one another such that the virtual image has visual continuity across a common edge between adjacent panels. Each of the plurality of viewing panels can have an inclination angle with respect to the display screen, and the inclination angles for each of the viewing panels may be substantially the same. In one aspect, the system may include a control device 470 configured to enable a viewer to interact with displayed images.

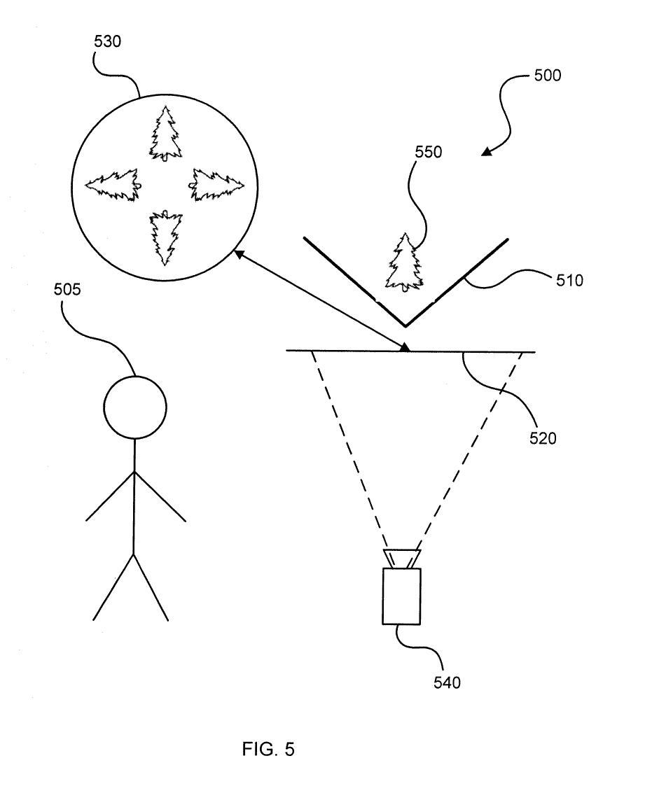

In one embodiment, the system may comprise a large footprint multi-panel apparatus having an image projector for each viewing panel. The system may be configured to display a full size virtual object. For example, in one aspect, the system may be at least large enough to display a full-size virtual car. In certain large scale applications, one or more projects may be used to provide an image for reflection by a single viewing panel. Alternatively, as shown in FIG. 5, the system may comprise a small footprint stand alone multi-panel system configured in a vertical arrangement where at least one of a display screen and an image formation mechanism can be configured to provide images for multiple display panels. The system of the present invention may be configured into a variety of specific shapes and sized as required in order to provide a display with specifically desired characteristics.

FIG. 5 shows a cross-sectional side view of a multi-panel virtual image display system using a projector and with a screen below the display panels in accordance with one embodiment of the present invention. A viewer 505 can view a virtual image 550 produced within the reflective panel arrangement 510. The virtual image may be created by rays from the screen 520 reflecting off of the reflective viewing panels. An image on the screen may be projected onto the screen by one or more projectors 540. The screen may be partially translucent so that an image is produced on a back of the screen and then be reflected by the viewing panels to form the virtual image. As shown in the figure, a single projector or image formation device may be used to form an image for multiple viewing panels. The projector can be configured to project an image 530 comprising a number of images equivalent to a number of viewing panels. For example, as shown in FIG. 5, the system comprises four viewing panels and the projector projects an image with four sub-images, one for each viewing panel. The sub-images can be positioned relative to one another and projected such that a virtual seamless image with proper continuity and alignment between viewing panels may be created on each of the viewing panels.

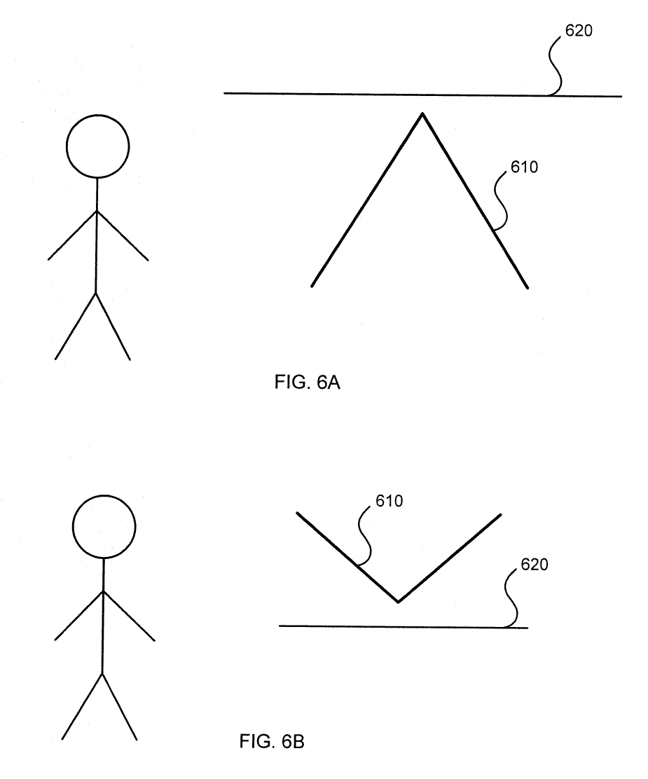

Referring to FIGS. 6A-6B, embodiments of systems are shown in which the display screen 620 comprises an active display screen configured to display an image from which a virtual image can be created within a viewing panel arrangement 610. The active display screen may comprise any suitable form of active display. In various embodiments, the active display screen is selected from a group consisting of LCD, LED and plasma flat display screens. An image formation mechanism be integrally formed with or operably connected to the active display screen. In one aspect, the image formation mechanism may comprise electronics operable to produce an image on the active display screen.

In one embodiment, a multiple panel apparatus for displaying a virtual panoramic image viewable from multiple viewing angles is provided. The apparatus comprises a plurality of substantially transparent reflective panels. A passive display screen can be positioned proximate to the reflective panels. An image generating system can be operable to project optical image data onto the display screen. The passive screen and the image generating system can be positioned relative to the transparent reflective panels such that a virtual image is viewable to viewers as a free floating midair three dimensional image from approximately a 60° to 360° viewing angle around the display apparatus. The image generating system may comprise a system selected from the group consisting of LCD, LED, plasma panel, and optical projector.

In another embodiment, a multiple panel system for displaying a virtual image viewable from multiple viewing angles is provided with variable transparency reflective viewing panels. A plurality of substantially reflective viewing panels, the transparency of which can be changed manually/electronically or by any other means, are arranged relative to one another in at least a partially closed enclosure arrangement. Such variably transparent panels may be state-variable (or variable-state) panels. The state-variable panels may comprise a transparent state and a non-transparent state. The state-variable panels may further comprise semi-transparent states having a degree of transparency between the transparent state and the non-transparent state. When the panels are in the non-transparent state, or in a scattering mode, one or more image projectors can be used to form image displays on the panels. When the panels are in transparent or semi-transparent state, or transparent mode, a display screen oriented with respect to the viewing panels may be positioned such that an image displayed on the display screen creates a virtual image viewable from multiple angles. The virtual image may be panoramic and/or appear to float in free space. An image formation mechanism may be included in the system and be operable to display an image onto the display screen. As described herein, the image formation mechanism may be formed with active display devices, or may be in the form of a projector or other suitable device in the case of a passive display screen. In one aspect, the state-variable panels may be formed from liquid crystal materials, such as Polymer-Dispersed Liquid Crystals (PDLC), cherester liquid crystal, and so forth. A state change of one or more viewing panels does not need to be synchronized with other viewing panels and the states of panels do not need to be the same.

In one embodiment, the system may comprise both an active and a passive display screen. For example, a state-variable substrate may be placed in front of an active display. When the state-variable substrate is in a non-transparent state, a projector may be used to project an image onto the state-variable substrate and the state-variable substrate may be effectively used as a passive display screen. When the state-variable substrate is a non-transparent state, the active display behind the state-variable substrate may provide an image source for the virtual image.

For digital signage display advertisements, quantitative measurement of effectiveness may be difficult. In many instances, there may be no meaningful way to know if a viewer is near a display screen or whether the viewer is viewing the display. Lack of effectiveness measures has slowed growth and widespread adoption of digital signage technologies. Lack of accurate counting of viewers and their behavior can undermine effectiveness of digital signage in targeting preferred audience and designing appropriate ads. Further, advertisers usually pay for advertisements based on viewership, or CPM (Cost Per thousand impressions, where M is the roman numeral of 1000). Pricing advertisements for particular locations and time slots can be complicated or difficult due to lack of viewer counting data.

Accordingly, the display systems provided herein may further comprise an infra-red reflection detector configured to detect infra-red reflection from a human eyeball and to count a number of human eyeballs viewing the virtual image. The systems may also comprise a viewer detector configured to detect and track viewer motion in an area surrounding the apparatus.

A camera or other form of detector may be used to capture and or detect moving targets. In one aspect, the camera may provide a 360° video source which may provide images from 360° surrounding the display system. A computing device may be configured to detect moving targets. Examples of specific methods for detection of moving targets include without limitation:
(a) Temporal differencing (two-frame or three frame subtractions);
(b) Background subtraction; and
(c) Optical flow.
   Combinations of such methods can also be used.

Temporal differencing is very adaptive to dynamic environments, but generally does a poor job of extracting all relevant feature pixels. Background subtraction provides the most complete feature data, but may be sensitive to dynamic scene changes due to lighting and extraneous events. Optical flow can be used to detect independently moving targets in the presence of camera motion; however, optical flow computation methods can be complex and inapplicable to real-time algorithms (at least absent special hardware).

Accordingly, an adaptive background subtraction approach is proposed which can make background subtraction more robust and adaptive to environmental dynamics. For adaptive background subtraction, for each pixel value in the Nth frame, a running average and standard deviation can be maintained by temporal filtering. A statistical model can be generated using averages and standard deviations. This statistical model can incorporate noise measurements to determine foreground pixels, rather than a simple threshold, thus enhancing robustness of the background subtraction algorithm.

Once a target is detected, a target's motion can be tracked over time. The tracking can be used to build a temporal model of activity. As a first step, objects (containing the detected targets) generated by motion detection can be matched from frame-to-frame. A record of each object can be kept with motion parameters. For example, the record may include a trajectory (position and velocity as function of time) in image coordinates. Associated camera calibration parameters can also form a part of the record so that the target's trajectory can be normalized to an absolute common coordinate system. Object data may also form a part of the record. Object data may include information such as object size, centroid, and color histogram. A position and velocity of a target from a last time step can be used to determine a predicted position for the object at a current or other given time. Based on this, a matching cost index between a known target and a current moving objected can be maintained. Thus, matched targets or objects can be tracked and a motion trajectory can be obtained for each target.

Information about the number of detected viewers around the display system can be used as a base for counting the display viewership. However, advertisers may desire to know whether a viewer is looking at the display. To achieve this objective, a 360° infrared LED projector and a 360° video camera may be used to detect eyes in targets.

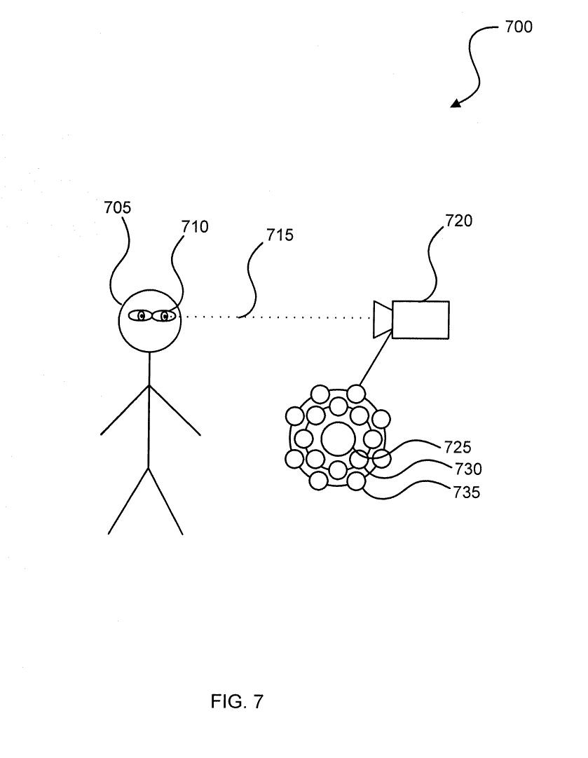

FIG. 7 depicts an eyeball counting camera design 700. Two sets of infrared LED rings 730, 735 (or projectors) may be mounted to a camera lens 730. An on-axis LED ring 73 5 can project bright infrared (IR) light flashes directly to a detected target. If there is a human eye present (or at least partially directed toward the camera), an image acquired by the camera can show a bright pupil reflection. To simplify detection, an off-axis LED ring 740 can be used which produces reflection from human eyeball surfaces with different characteristics. Images captured during an off-axis flash may possess black pupils. By synchronizing image acquisition timing of the camera with on-axis and off axis LED flashes, a bright and black pupil effect can be produced in alternate image frames. Simple image processing algorithms can be used to extract the presence and position of eyeballs. Because the system can detect and track objects or potential targets, a processing speed for eyeball tracking and detection can be sufficiently fast for real-time applications.

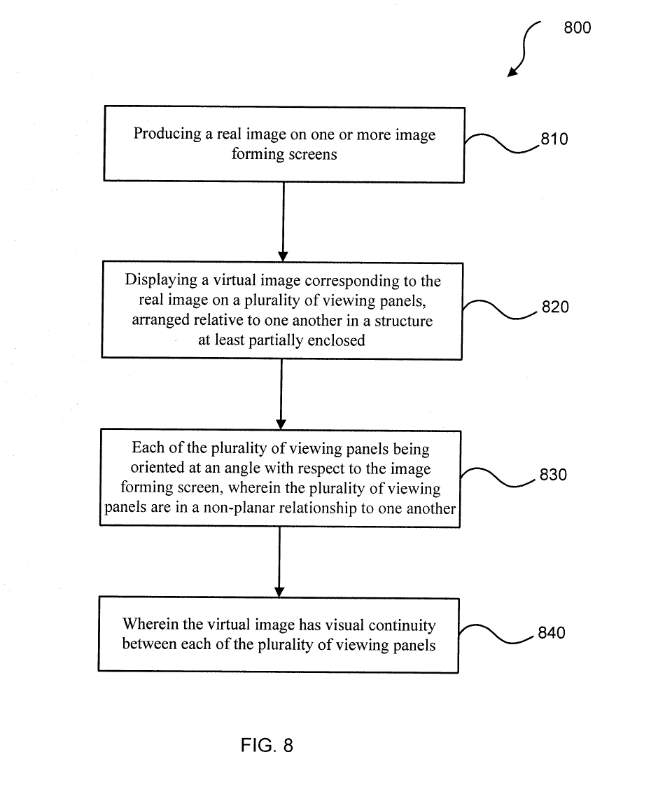

In accordance with an embodiment shown in FIG. 8, a method 800 for displaying a panoramic walk-around virtual image utilizing coherence combinations of multiple reflective panel surfaces is provided. A real image is produced 810 on one or more image forming screens. A virtual image corresponding to the real image is displayed 820 on a plurality of viewing panels arranged relative to one another in an at least partially enclosed structure, each of the plurality of viewing panels being oriented at an angle with respect to the image forming screen 830, and wherein the plurality of viewing panels are in a non-planar relationship to one another. The virtual image can have visual continuity between each of the plurality of viewing panels 840.

The multi-panel virtual image display can provide various advantages and benefits over schemes found in the prior art. The multi-panel virtual image display can over some of the visual fatigue of traditional two-dimensional display formats due to an overwhelming presence of such displays. Unlike online advertising which may count “per click” data, current advertising methods fail to provide an effective quantitative measure of how many “eyeballs” see a particular ad message. The multi-panel virtual image display tracking and counting system can overcome this deficiency and provide information about viewers, such as a number of viewers, position and trajectory of viewers, and a log of time spent by viewers to view a display (and this also can be correlation to the content displayed, where content may be video, text, three-dimensional models, pictures, etc.).

Additionally, the multi-panel virtual image display is scaleable and can be adapted to fit various different applications and markets. For example, the multi-panel virtual image display may be used in sizes and scales ranging from nano-sized units and miniature desktop units to large scale display units, and even to very large scale exhibition units. These design options, combined with the viewing tracking/counting capabilities, can provide numerous options and settings for advertisers to display products, communicate information, or provide entertainment to customers.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A multiple panel system for displaying a virtual image viewable from multiple viewing angles, comprising:
a plurality of reflective viewing panels arranged relative to one another in at least a partially closed enclosure arrangement;
a display screen oriented with respect to the viewing panels such that an image displayed on the display screen creates a virtual image viewable from multiple angles; and
an image formation mechanism operable to display an image onto the display screen.

2. The system of claim 1, wherein the viewing panels are oriented with respect to one another such that the virtual image has visual continuity across a common edge between adjacent panels.

3. The system of claim 1, wherein the image formation mechanism comprises an image projector.

4. The system of claim 1, wherein the display screen is an active display screen comprising a flat screen display device selected from the group consisting of LCD, LED and plasma flat.

6. The system of claim 1, wherein the viewing panels are arranged to form a closed polygon cone arrangement.

7. The system of claim 1, wherein each of the plurality of viewing panels has an inclination angle with respect to the display screen, and the inclination angles for each of the viewing panels are substantially the same.

8. The system of claim 1, wherein the image formation mechanism is positioned near a base region of the plurality of viewing panels, and the display screen is positioned near an apex region of the plurality of viewing panels.

9. The system of claim 1, wherein the system comprises a small footprint stand alone multi-panel system configured in a vertical arrangement, and wherein at least one of the display screen and the image formation mechanism is configured to provide images for multiple display panels.

10. The system of claim 1, wherein a transparency of the reflective viewing panels is variably adjustable.

11. The system of claim 1, wherein the system comprises a large footprint multi-panel apparatus having an image projector for each viewing panel, wherein the system is configured to display a full size virtual object.

12. A multiple panel apparatus for displaying a virtual panoramic image viewable from multiple viewing angles, comprising:
a plurality of substantially transparent reflective panels;
a passive display screen positioned proximate to the reflective panels;
an image generating system operable for projecting optical image data onto the display screen, wherein the passive screen and the image generating system are positioned relative to the transparent reflective panels such that a virtual image is viewable to viewers as a free floating midair three dimensional image from about 60-degree to about 360-degree viewing angles around the display apparatus.

13. The apparatus of claim 12, wherein the image generating system comprises a system selected from the group consisting of LCD, LED, plasma panel, and optical projector.

14. The apparatus of claim 12, wherein the transparent reflective panels are oriented with respect to one another such that the virtual image has visual continuity across a common edge between adjacent panels.

15. The apparatus of claim 12, wherein the plurality of substantially transparent reflective viewing panels are arranged relative to one another in at least a partially closed enclosure arrangement.

16. The apparatus of claim 12, wherein the projected optical image data further comprises stereo image data and the virtual image further comprises a stereo virtual image.

17. The apparatus of claim 12, wherein the image generating system comprises an image projector positioned in a base region of the plurality of viewing panels, and wherein the display screen comprises a reflective mirror configured to reflect a visual image from the image projector to the display screen.

18. The apparatus of claim 12, further comprising an infra-red reflection detector configured to detect infra-red reflection from a human eyeball and to count a number of human eyeballs viewing the virtual image.

19. The apparatus of claim 12, further comprising a viewer detector configured to detect and track viewer motion in an area surrounding the apparatus.

20. A method for displaying a panoramic walk-around virtual image utilizing coherence combinations of multiple reflective panel surfaces, comprising:
producing a real image on one or more image forming screens;
displaying a virtual image corresponding to the real image on a plurality of viewing panels, arranged relative to one another in a structure at least partially enclosed;
each of the plurality of viewing panels being oriented at an angle with respect to the image forming screen, wherein the plurality of viewing panels are in a non-planar relationship to one another; and
wherein the virtual image has visual continuity between each of the plurality of viewing panels.
